(19) United States
(12) Patent Application Publication
(10) Pub. No.: US 2014/0089072 A1
(43) Pub. Date: Mar. 27, 2014

(54) POSTING PURCHASE INFORMATION

(71) Applicant: Google Inc., Mountain View, CA (US)

(72) Inventors: Martin Brandt FREUND, Mountain View, CA (US); Momchil Filev, Mountain View, CA (US)

(73) Assignee: Google Inc., Mountain View, CA (US)

(21) Appl. No.: 13/626,822

(22) Filed: Sep. 25, 2012

(51) Int. Cl. G06F 15/16; G06Q 30/02; G06Q 20/22

(52) U.S. Cl. 705/14.27; 705/39; 705/14.53; 709/204

(57) ABSTRACT

Systems and methods for posting purchase information are provided. In some aspects, a representation of a set of purchases associated with a user of a social networking service is received. That content related to one or more purchases from the set of purchases is to be posted to the social networking service is determined based on a first set of rules. The content related to the one or more purchases is posted, in association with the user, to the social networking service in response to determining that the content is to be posted to the social networking service.

### BACKGROUND

The subject technology generally relates to social networking interfaces and, in particular, relates to posting offline purchase information via a social networking service.

Some people interact and share information about activities in which they engage with their social contacts via a social networking service, for example, by posting text or photographs related to their activities to the social networking service.

### SUMMARY

In some aspects, the disclosed subject matter relates to a computer-implemented method. The method includes receiving a representation of a set of purchases associated with a user of a social networking service. The method includes determining, based on a first set of rules, that content related to one or more purchases from the set of purchases is to be posted to the social networking service. The method includes posting, in association with the user, the content related to the one or more purchases to the social networking service in response to determining that the content is to be posted to the social networking service.

These and other embodiments can include one or more of the following features. The set of purchases includes offline purchases and the first set of rules includes a user manually selecting the one or more purchases from the set of purchases for posting to the social networking service. At least one rule within the first set of rules is entered by the user. The first set of rules includes at least one rule that is entered by a merchant of at least one purchase in the set of purchases and affirmatively approved by the user. The set of purchases is associated with an electronic purchase service provider. The set of purchases includes at least one payment with money. At least one purchase in the set of purchases is associated with a payment with cash, and the representation of the set of purchases includes an indication, from a merchant of the at least one purchase, that the merchant received the payment. The set of purchases includes at least one use of a coupon. The content related to the one or more purchases includes one or more content items. The method also includes selecting the one or more content items based on a second set of rules approved by the user. The content items include one or more of a merchant name, a merchant geographic location, a transaction price, a transaction time, a good or service associated with the transaction, a number of purchases from a specific merchant within a time period, or a frequency of purchases from the specific merchant within the time period. Posting the content related to the one or more purchases to the social networking service includes determining, based on a third set of rules approved by the user, one or more members of the social networking service to whom to provide the content related to the one or more purchases, and providing, to at least a portion of the one or more members of the social networking service, the content related to the one or more purchases. The one or more members of the social networking service include one or more social circles of the user. The method also includes receiving, from the user, via the social networking service, an indication of preference for a first merchant via the social networking service. The method also includes determining that content related to a specific purchase of the user with the first merchant is posted within the social networking service. The method also includes providing, to at least one social contact of the user in the social networking service, the indication of preference for the first merchant of the user in conjunction with the content related to the specific purchase. The method also includes determining, based on the content related to the one or more purchases posted to the social networking service, that the user has earned a reward. The method also includes providing the reward to the user via the social networking service. The method also includes determining, based on data posted within the social networking service, that a threshold number of social contacts of the user engaged in first purchases with a merchant of the one or more purchases. The method also includes providing a reward to the user via the social networking service based on the threshold number of the social contact having engaged in the first purchases with the merchant. The first purchases include offline purchases.

The disclosed subject matter also relates to a computer-readable medium encoded with executable instructions. The instructions include code for receiving a representation of a set of purchases associated with a user of a social networking service. The instructions include code for determining, based on a first set of rules, that content related to one or more purchases from the set of purchases is to be posted to the social networking service. The instructions include code for posting, in association with the user, the content related to the one or more purchases to the social networking service in response to determining that the content is to be posted to the social networking service.

These and other embodiments can include one or more of the following features. At least one purchase in the set of purchases is associated with a merchant. The first set of rules includes at least one rule that is entered by the merchant and affirmatively approved by the user. At least one rule within the first set of rules is not entered by the user.

The disclosed subject matter further relates to a system. The system includes one or more processor and a memory. The memory includes instructions configured to be executed by the one or more processors. The instructions include code for receiving a representation of a set of purchases associated with a user of a social networking service. The instructions include code for determining, based on a first set of rules approved by the user, that content related to one or more purchases from the set of purchases is to be posted to the social networking service. The instructions include code for posting, in association with the user, the content related to the one or more purchases to the social networking service in response to determining that the content is to be posted to the social networking service.

These and other embodiments can include one or more of the following features. The instructions also include code for determining, based on the content related to the one or more purchases posted to the social networking service, additional information of interest to the user. The instructions also include code for presenting, via the social networking service, the additional information to the user. The additional information includes an advertisement.

Advantageously, aspects of the subject technology allow users to post information related to their offline purchases to a social networking service. As a result, users may share interesting information about their offline purchases with their social contacts. Also, a merchant can encourage (e.g., via promotional offers or rewards programs) customers to post information related to their offline purchases to the social networking service, providing advertising for the merchant and letting the social contacts of the customers know about the customers' affinity for the merchant.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example of a system for posting offline purchase information via a social networking service.

FIG. 2 illustrates an example of a data structure for representing an offline purchase.

FIG. 3 illustrates an example of a data structure for representing a posted data item in a social networking service.

FIG. 4 illustrates an example process by which offline purchase information may be posted via a social networking service.

FIG. 5 illustrates an example process by which content related to an offline purchase may be provided to a social contact of a user.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, certain structures and components are shown in block diagram form in order to avoid obscuring the concepts of the subject technology.

As set forth above, some people interact and share information about their activities with their social contacts via a social networking service, for example, by posting text or photographs related to their activities to the social networking service. In some implementations, when a user of a social networking service engages in an online purchase (e.g., purchasing a book from an online bookstore), the user may be provided with a link to post some information about the online purchase (e.g., the time of the transaction, the title of the book, the name of the bookstore, the price of the book, an image of the book, etc.) to the social networking service. However, when the user engages in an offline purchase (e.g., purchasing a book from a local brick-and-mortar bookstore), the user may not be provided with a similar link to post information about the offline purchase, as the user may not be accessing the Internet via a computing device at the time of the transaction. As the foregoing illustrates, an approach for posting information about an offline purchase via a social networking service may be desirable.

The subject technology is related to posting offline purchase information via a social networking service. The phrase “offline purchase” encompasses its plain and ordinary meaning In some aspects, an offline purchase may refer to a purchase at a local or brick-and-mortar business or a purchase that is completed by visiting a physical geographic location of a business, rather than a purchase that is completed via a network, e.g., the Internet. A purchase may be a purchase of a good or a service or a use of a coupon to obtain the good or the service for free or at a discount. A purchase may include a financial transaction or a transaction paid for with money. In some implementations, a server receives, from a purchase data repository, a representation of a set of offline purchases associated with a user of a social networking service. Each offline purchase is associated with a merchant (e.g., a business, government organization, or other entity selling a good or a service). The purchase data repository may be associated with an electronic purchase service provider. The server determines, based on a first set of rules approved by the user, that content related to one or more offline purchases from the set of offline purchases is to be posted to the social networking service. For example, a user could specify that offline bookstore or restaurant purchases, but not other purchases, are to be posted to the social networking service. The server posts, in association with the user, the content related to the one or more offline purchases to the social networking service in response to determining that the content is to be posted to the social networking service based on the first set of rules.

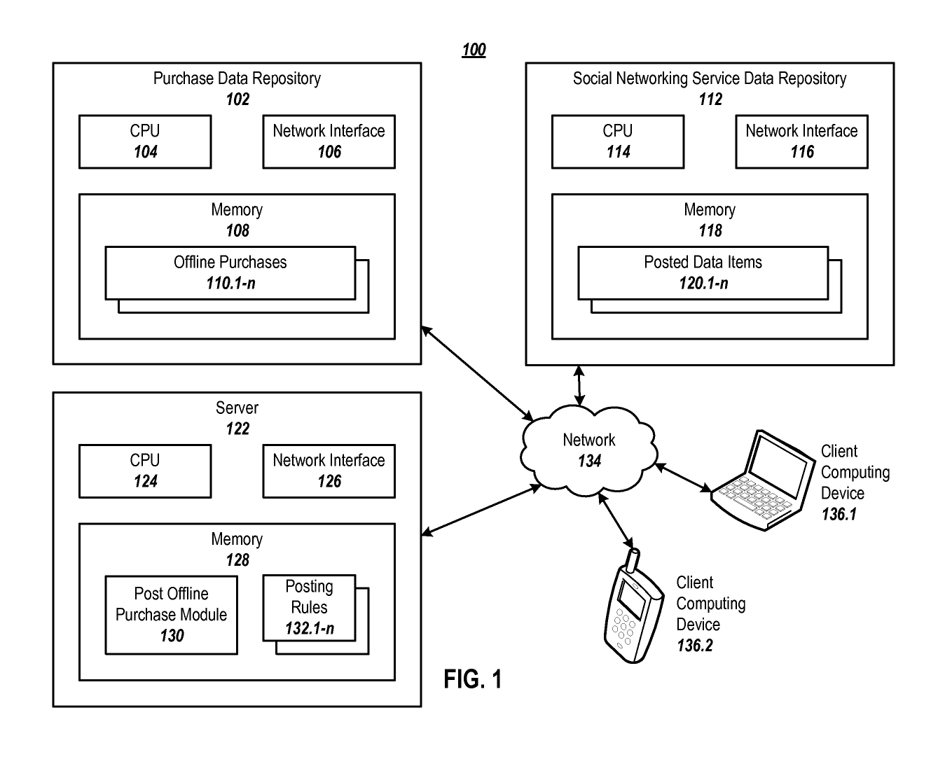

FIG. 1 illustrates an example of a system 100 for posting offline purchase information via a social networking service.

As shown, the system 100 includes a purchase data repository 102, a social networking service data repository 112, a server 122, and client computing devices 136.1-2, connected with one another via a network 134. The network 134 may include the Internet, an intranet, a local area network, a wide area network, a wired network, a wireless network, or a virtual private network (VPN). As illustrated, the system 100 includes a single purchase data repository 102, a single social networking service data repository 112, a single server 122, and two client computing devices 136.1-2. However, the subject technology may be implemented with any number of the above-listed machines. In some aspects, two or more of the above-listed machines (e.g., the purchase data repository 102 and the server 122) may be implemented as a single machine or two or more separate machines may implement the functions of one of the above-listed machine (e.g., the server 122 may be implemented as two or more servers).

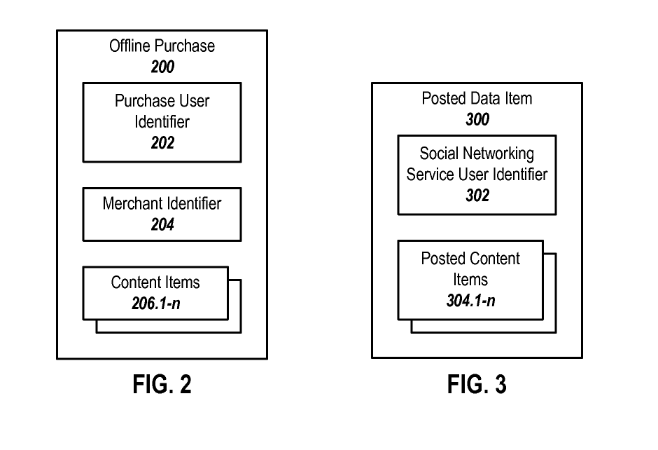

As shown, the purchase data repository 102 includes a central processing unit (CPU) 104, a network interface 106, and a memory 108. The CPU 104 includes one or more processors. The CPU 104 is configured to execute computer instructions that are stored in a computer-readable medium, for example, the memory 108. The network interface 106 is configured to allow the purchase data repository 102 to transmit and receive data in a network, e.g., network 134. The network interface 106 may include one or more network interface cards (NICs). The memory 108 stores data or instructions. The memory 108 may be one or more of a cache unit, a storage unit, an internal memory unit, or an external memory unit. As illustrated, the memory 108 includes representations of offline purchases 110.1-n. The representations of offline purchases 110.1-n are described in more detail in conjunction with FIG. 2, below.

The purchase data repository 102 may be associated with one or more electronic purchase or third party service providers. The offline purchases 110.1-n may represent activity recorded by the electronic purchase or third party service providers, for example, purchases of goods or services or uses of coupons.

As shown, the social networking service data repository 112 includes a central processing unit (CPU) 114, a network interface 116, and a memory 118. The CPU 114 includes one or more processors. The CPU 114 is configured to execute computer instructions that are stored in a computer-readable medium, for example, the memory 118. The network interface 116 is configured to allow the social networking service data repository 112 to transmit and receive data in a network, e.g., network 134. The network interface 116 may include one or more network interface cards (NICs). The memory 118 stores data or instructions. The memory 108 may be one or more of a cache unit, a storage unit, an internal memory unit, or an external memory unit. As illustrated, the memory 118 includes representations of posted data items 120.1-n. The representations of posted data items 120.1-n are described in more detail in conjunction with FIG. 3, below.

The social networking service data repository 112 is associated with a social networking service. The posted data items 120.1-n correspond to data posted to the social networking service, for example, text posts, images, videos, audio files, representations of online purchases, or representations of offline purchases.

The data repositories 102 and 112 may be implemented as one or more databases or as any other data storage structures. In some aspects, a single machine may include both data repositories 102 and 112. In some aspects, the data repositories 102 and 112 may be implemented as two separate machines or as data repository farms including multiple different machines.

The server 122 may be implemented as a single machine with a single processor, a multi-processor machine, or a server farm including multiple machines with multiple processors. As shown, the server 122 includes a central processing unit (CPU) 124, a network interface 126, and a memory 128. The CPU 124 includes one or more processors. The CPU 124 is configured to execute computer instructions that are stored in a computer-readable medium, for example, the memory 128. The network interface 126 is configured to allow the social networking service data repository 122 to transmit and receive data in a network, e.g., network 134. The network interface 126 may include one or more network interface cards (NICs). The memory 128 stores data or instructions. The memory 128 may be one or more of a cache unit, a storage unit, an internal memory unit, or an external memory unit. As illustrated, the memory 128 includes a post offline purchase module 130 and posting rules 132.1-n.

The posting rules 132.1-n may correspond to multiple sets of posting rules. Each set of posting rules is for a user account in the purchase data repository 102 that is linked to an account in the social networking service of the social networking service data repository 112. For example, if the purchase data repository 102 is associated with a bank, the user may link his/her bank account to his/her account in the social networking service. The user affirmatively provides permission for his/her bank account and social networking service account to be linked and the user can withdraw his/her permission at any time. Each set of posting rules 132.k is approved by the associated user. In some aspects, the user enters the posting rules him/herself. For example, the user can specify that he/she wants to share all restaurant purchases below $100 via the social networking service. In some aspects, a merchant enters the posting rules and the user approves the posting rules. For example, a merchant could specify a rule that users will share items purchased from the store of the merchant but not the price, and the users could accept those rules. To incentivize a user to accept rules set by a merchant, the merchant could offer a reward or incentive program. For example, a brick-and-mortar bookstore could offer a free book to a user who purchases at least five books from the brick-and-mortar bookstore during the month of July 2012 and shares the purchases via the social networking service. A coupon to obtain the free book could be transmitted to the user via the social networking service.

The post offline purchase module 130 is configured to receive, from the purchase data repository 102, a representation of a set of offline purchases (e.g., all or a portion of offline purchases 110.1-n) associated with a user of the social networking service coupled to the social networking service data repository 112. The post offline purchase module 130 is configured to determine, based on a first set of rules (e.g., posting rules 132.k) approved by the user, that content related to one or more offline purchases from the set of offline purchases associated with the user is to be posted to the social networking service. The post offline purchase module is configured to post, in association with the user, the content related to the one or more offline purchases to the social networking service (e.g., by creating a posted data item 120.k in the social networking service data repository 112) in response to determining that the content is to be posted to the social networking service.

Client computing devices 136.1-2 may be used to enter information about offline purchases 110.1-n to be stored in the purchase data repository 102 or to view posted data items 120.1-n in the social networking service. The client computing device 136 may be a laptop computer, a desktop computer, a mobile phone, a personal digital assistant (PDA), a tablet computer, a netbook, a television with one or more processors embedded therein or coupled thereto, a physical machine, a virtual machine, a credit card reader, or a near field communication (NFC) reader coupled with a payment accepting device. For example, a mobile phone can be used to make an offline purchase (e.g., at a local brick-and-mortar business) via a bank account associated with the mobile phone. A credit card reader that accepts credit card payments can provide an electronic receipt to an electronic messaging address that is associated with a user account of a social networking service.

FIG. 2 illustrates an example of a data structure for representing an offline purchase.

The offline purchase 200 can correspond to an offline purchase 110.1-n stored in the purchase data repository 102. The representation of the offline purchase 200 includes a purchase user identifier 202, a merchant identifier 204, and content items 206.1-n.

The purchase user identifier 202 identifies a user, for example, via a bank account, an electronic messaging address, etc. With appropriate permissions from the user, the purchase user identifier 202 may be coupled with a social networking service user identifier (e.g., social networking service user identifier 302, as described in detail in conjunction with FIG. 3, below) to allow offline purchase information of the user to be associated with his/her social networking service account.

The merchant identifier 204 identifies a merchant involved in the offline purchase 200. The merchant may be any entity that sells or provides goods or services, for example, a business or a government organization. The merchant identifier 204 may be, for example, a name of the merchant, e.g., “First Café” or “Second Bookstore.”

The content items 206.1-n include additional content related to the offline purchase 200 for example, a merchant geographic location, a transaction price, a transaction time, a good or service associated with the transaction, a number or frequency of purchases between the user and the merchant during a specified time period, or an image of the good or service associated with the transaction.

FIG. 3 illustrates an example of a data structure for representing a posted data item in a social networking service.

The representation of the posted data item 300 includes a social networking service user identifier 302 and posted content items 304.1-n. The social networking service user identifier 302 identifies a user of a social networking service, for example, by name, electronic messaging address, or username. With appropriate permissions from the user, the social networking service user identifier 302 of the user may be coupled to the purchase user identifier 202 of the user to allow offline purchase information of the user to be associated with his/her social networking service account, so that a posted data item 300 can correspond to an offline purchase 200.

The posted content items 304.1-n include data that was posted to the social networking service, for example, text, images, audio files, or videos. If the posted data item 300 corresponds to an offline purchase 200, the posted content items 304.1-n can correspond to the content items 206.1-n of the offline purchase 200 or any other information about the offline purchase 200.

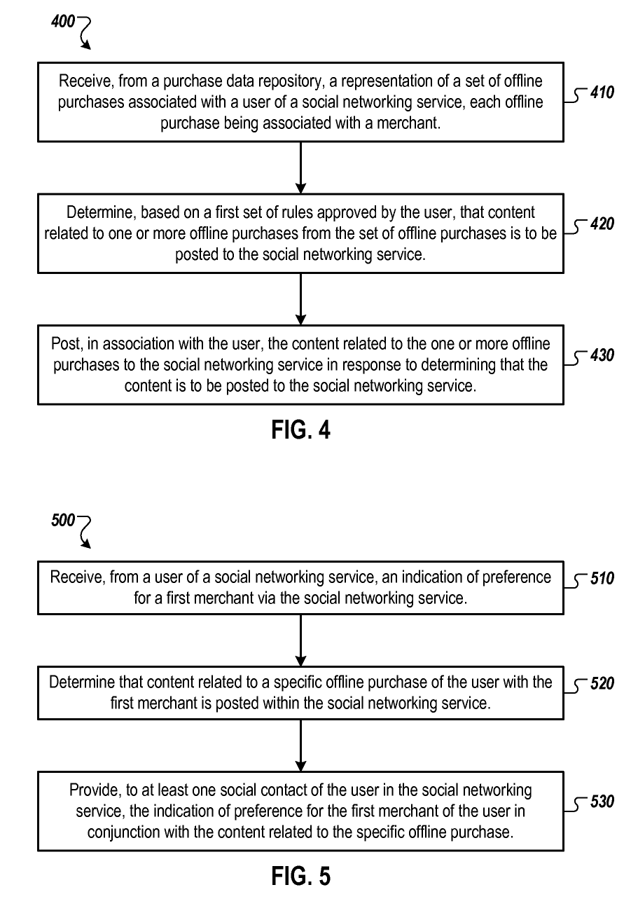

FIG. 4 illustrates an example process 400 by which offline purchase information may be posted via a social networking service.

The process 400 begins at step 410, where a server (e.g., server 122) receives, from a purchase data repository (e.g., purchase data repository 102) a representation of a set of offline purchases associated with a user of a social networking service. Each offline purchase is associated with a merchant.

The set of offline purchases may include purchases or uses of coupons. In some aspects, one of the purchases may be paid for via a bank account or credit card. The purchase data repository may be associated with the bank or credit card company and may obtain the offline purchase information via the bank or credit card transaction processing system. Alternatively, a purchase in the set of offline purchases may be paid for with cash. The representation of the purchase paid for with cash may include or be based on an indication from the merchant that the merchant received the cash payment, for example, via an electronic receipt stored in the purchases data repository. The electronic receipt may be provided to the user, for example, via an electronic message. The user affirmatively provides permission for information about his/her offline purchases to be provided to the social networking service and posted in the social networking service. The user may withdraw this permission at any time.

In step 420, the server determines, based on a first set of rules approved by the user, that content related to one or more offline purchases from the set of offline purchases is to be posted to the social networking service. Rules within the first set of rules may be entered by the user or entered by a merchant and approved by the user. The rules entered by the merchant are affirmatively approved by the user. For example, the user may select a button indicating that he/she understands and accepts the rules entered by the merchant. If the rules are entered by the merchant, the rules may not be entered by the user.

In some aspects, the first set of rules are manually set by the user. For example, the user may manually review his/her offline purchases and manually select one or more of his/her offline purchases to post to the social networking service. Alternatively, the rules may include predetermined rules based on which the server can decide to post offline purchases to the social networking service without additional user action. For example, a user who wishes to share his/her restaurant meals with his/her social contacts but does not wish to flaunt his/her wealth may create a rule that purchases at restaurants below $50 are automatically posted to the social networking service. If the user who created the rule orders a meal at ABC Restaurant for $25, the representation of the ABC Restaurant transaction is automatically posted to the social networking service.

In some aspects, the user can initiate the posting of an offline purchase. With appropriate permissions, the server can verify that the user made the purchase (e.g., with the purchase data repository 102). Alternatively, in some implementations, the server may not verify that the user made the purchase. The server may allow or disallow the user-initiated posting of the offline purchase, for example, based on the verification.

In step 430, the server posts, in association with the user (e.g., via the user's social networking service account), the content related to the one or more offline purchases to the social networking service in response to determining that the content is to be posted to the social networking service. The content related to the one or more offline purchases posted to the social networking service may include one or more content items based on a second set of rules approved by the user. Similarly to the first set of rules, the second set of rules may be entered by the user or entered by a merchant and approved by the user. The content items (e.g., content items 206.1-n) may include one or more of a merchant name, a merchant geographic location, a transaction price, a transaction time, a good or service associated with the transaction, a number of purchases from a specific merchant within a time period, or a frequency of purchases from the specific merchant within the time period.

For example, second set of rules may indicate that a geographic location, but not a time, of an offline purchase is to be posted. Alternatively, the second set of rules may indicate that the goods or services purchased, but not the price of the offline purchase may be posted. In another example, the second set of rules may indicate that all available offline transaction information (e.g., time, geographic location, merchant name, items, price, etc.) is to be shared. In yet another example, a user may share his/her purchase frequency or number of purchases in a time period via the social networking service. For example, a user may share that he/she ate at ABC Restaurant four times during the last week or that he/she had drinks at DEF Bar once a week during the last year.

In some implementations, a third set of rules approved by the user may be used to determine one or more members of the social networking service to whom to provide the content related to the one or more purchases. Similarly to the first set of rules and the second set of rules, the third set of rules may be entered by the user or entered by a merchant and approved by the user. The content related to the one or more purchases may be provided to at least a portion of the one or more members of the social networking service (e.g., those who log in to the social networking service during a predetermined time period, e.g., two weeks after when the transaction is posted to the social networking service). The one or more members may be identified based on any characteristics known to the social networking service, for example, membership in a social circle. In one example, a user may choose to share his/her supermarket offline purchases with members of his/her “coworkers” social circle and share his/her cinema offline purchases with members of his/her “friends” social circle.

As used herein, “social circles” are categories to which a user can assign their social networking contacts and better control the distribution and visibility of social networking messages. In accordance with the subject disclosure, a social circle is provided as a data set defining a collection of contacts that are associated with one another. A social circle can be described from the perspective of an individual that is the center of a particular collection of socially interconnected people, or from the aggregate perspective of a collection of socially interconnected people. A social circle can have narrowly defined boundaries, all of the members of the social circle may be familiar with one another, and permission may be required for a member to join a social circle. A user of an electronic device may define a social circle, and the social circle, as a data set defining a collection of contacts, may reflect a real-life social circle of the user.

In one example, a user of an electronic device (e.g., client computing device 136) may have different groups of friends, coworkers and family, and there may be some overlap among those groups (e.g., a coworker who is also considered to be a friend, a family member who is also a coworker). Through the creation and use of social circles, the user can organize and categorize social networking contacts into various different groupings.

In some aspects, a merchant may indicate to the social networking service that the merchant will provide a reward to a user based on his/her offline purchases posted in the social networking service. For example, to encourage users to shop at GHI Clothing Store and advertise GHI Clothing Store to their social contacts, GHI Clothing Store may run a promotion that all users who share five offline purchases with GHI Clothing Store with at least 10 other users of the social networking service, during the month of July 2012 will receive a coupon for a free shirt, and the user who shares the largest number of offline purchases at GHI store with at least 10 other users will receive a $100 gift card. After the completion of the requirement to receive the reward, the reward may be provided to the users via the social networking service (e.g., via an electronic message within the social networking service).

In some implementations, a user may post an offline purchase at JKL Café to the social networking service. With appropriate permissions from the user, JKL Café may later determine that a threshold number (e.g., three) of the users social contacts also posted offline purchases at JKL Café (or, alternatively, online purchases, if JKL Café has an online store) to the social networking service. Based on this information, JKL Café may conclude that the user is promoting JKL Café to his/her social contacts and may provide the user with a reward (e.g., a coupon for a gift card or a free or discounted item(s)) to keep the user interested in JKL Café.

In additional implementations, the server may determine, based on content related to the one or more offline purchases posted to the social networking service, additional information of interest to the user. For example, a user who frequently engages in offline purchases at bookstores in San Francisco is likely to be interested in books and live near San Francisco. The server may present, via the social networking service, the additional information to the user. For example, the user who is likely to be interested in book may see an advertisement for an online bookstore or a brick-and-mortar bookstore in San Francisco with which the user either has or has not yet engaged in offline purchases.

In some aspects, the process 500, described in detail in conjunction with FIG. 5, below, may be initiated after step 430. After step 430, the process 400 ends.

FIG. 5 illustrates an example process 500 by which content related to an offline purchase may be provided to a social contact of a user. The process 500 may be initiated, for example, after step 430 of the process 400 described above in conjunction with FIG. 4.

The process 500 begins at step 510, where a server (e.g., server 122) receives, from a user of a social networking service (e.g., via a client computing device 136), an indication of a preference for a first merchant (e.g., ABC Restaurant) via the social networking service. The user affirmatively chooses to provide the indication of the preference for the first merchant and may withdraw the indication of preference at any time.

In step 520, the server determines that content related to a specific offline purchase of the user with the first merchant (e.g., a meal of the user at ABC Restaurant that was purchased offline) is posted within the social networking service (e.g., posted via operation of the process 400 of FIG. 4).

In step 530, the server provides, to at least one social contact (e.g., a member of a social circle) of the user in the social networking service, the indication of preference for the first merchant of the user in conjunction with the content related to the specific offline purchase. As a result, the social contact receives a powerful endorsement, including an indication of preference and an indication of an offline purchase, of the first merchant by the user and may be encouraged to do business with the first merchant. After step 530, the process 500 ends.

Various uses of the subject technology will be apparent. In one example, a fast food diner may run a competition to reward the person who eats the largest number of meals at the fast food diner over the course of a predetermined time period (e.g., one year). To indicate that a customer ate a meal at the fast food diner, the customer may provide an indication of his/her purchase at the fast food diner via the social networking service. As a result, the social contacts of the customer can learn that the customer likes the fast food diner. With appropriate permissions, the indications of the purchases may be posted, in real-time after a payment for the purchase is made, to the social contacts of the customer and to a webpage within the social networking service for the competition.

In another example, a group of friends may travel together to Las Vegas for a weekend and agree to share the costs of the trip. During the trip, upon making a payment, a friend making the payment may post an indication the payment to the social networking service to allow members of the group of friends and/or other social contacts of the friend making the payment to know about the payment. After the trip is completed and the friends reimburse one another for the expenses, the friends can log into the social networking service to determine which friend paid for which expenses and how much was paid.

Although certain examples provided herein describe a user's information being stored in memory, the user can delete the user information from memory and/or opt out of having the user information stored in memory. In example aspects, the user can adjust appropriate privacy settings to selectively limit the types of user information stored in memory, or select the memory in which the user information is stored (e.g., locally on the user's device as opposed to remotely a server). In example aspects, the user information does not include and/or share the specific identification of the user (e.g., the user's name) unless otherwise specifically provided or directed by the user.

In various aspects, the subject disclosure provides for accessing information stored about users (e.g., offline purchases, indications of preference, social contacts, etc.). In such cases, a user may opt-out of having the system (e.g., a server or a data repository) store the user information or the user may need to provide affirmative permission to have the system store or access the user information as discussed for the various aspects.

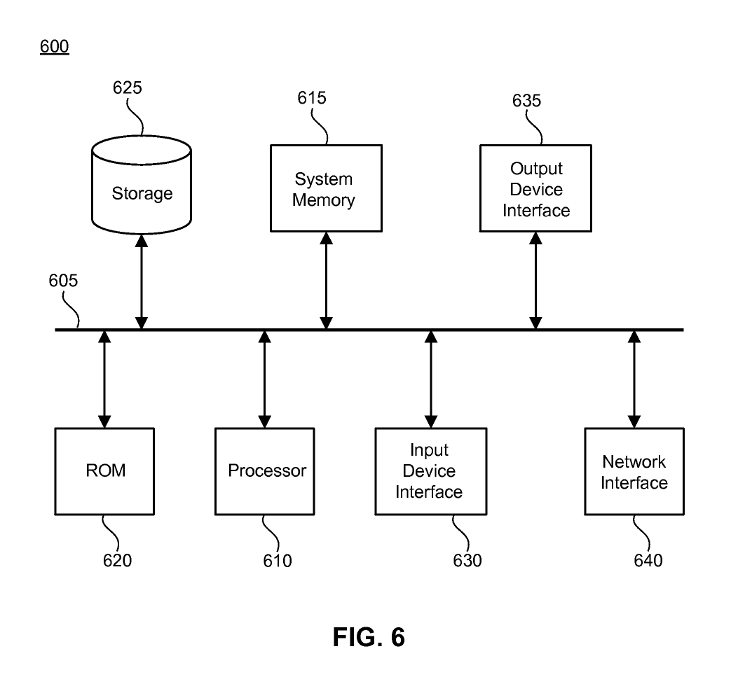

FIG. 6 conceptually illustrates an electronic system 600 with which some implementations of the subject technology are implemented. For example, one or more of the purchase data repository 102, the social networking service data repository 112, the server 122, or the client computing devices 136.1-2 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for posting offline purchase information via a social networking service in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touchscreen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method comprising:
receiving, at one or more computers, a representation of a set of purchases associated with a user of a social networking service;
determining, by the one or more computers, based on a first set of stored, predetermined rules for posting purchase information to the social networking service and for identifying a portion of the set of purchases, one or more purchases from the set of purchases content related to which is to be posted to the social networking service, wherein the one or more purchases are not manually indicated by the user, and wherein the first set of stored, predetermined rules for posting purchase information to the social networking service comprises rules based on a purchase price or a merchant type for a corresponding purchase; and
posting, in association with the user, the content related to the one or more purchases to the social networking service in response to determining that the content is to be posted to the social networking service.

2. The method of claim 1, wherein the set of purchases comprises offline purchases.

3. The method of claim 1, wherein at least one rule within the first set of rules is entered by the user.

4. The method of claim 1, wherein the first set of rules comprises at least one rule that is entered by a merchant of at least one purchase in the set of purchases and affirmatively approved by the user.

5. The method of claim 1, wherein the set of purchases is associated with an electronic purchase service provider.

6. The method of claim 1, wherein the set of purchases comprises at least one payment with money.

7. The method of claim 1, wherein the at least one purchase in the set of purchases is associated with a payment with cash, and wherein the representation of the set of purchases comprises an indication, from a merchant of the at least one purchase, that the merchant received the payment.

8. The method of claim 1, wherein the set of purchases comprises at least one use of a coupon.

9. The method of claim 1, wherein the content related to the one or more purchases comprises one or more information items, the method further comprising:
selecting the one or more information items based on a second set of rules approved by the user.

10. The method of claim 9, wherein the one or more information items comprise one or more of a merchant name, a merchant geographic location, a transaction price, a transaction time, a good or service associated with the transaction, a number of purchases from a specific merchant within a time period, or a frequency of purchases from the specific merchant within the time period.

11. The method of claim 1, wherein posting the content related to the one or more purchases to the social networking service comprises:
determining, based on a third set of rules approved by the user, one or more members of the social networking service to whom to provide the content related to the one or more purchases; and
providing, to at least a portion of the one or more members of the social networking service, the content related to the one or more purchases.

12. The method of claim 11, wherein the one or more members of the social networking service comprise one or more social circles of the user.

13. The method of claim 1, further comprising:
receiving, from the user, via the social networking service, an indication of preference for a first merchant via the social networking service;
determining that content related to a specific purchase of the user with the first merchant is posted within the social networking service; and
providing, to at least one social contact of the user in the social networking service, the indication of preference for the first merchant of the user in conjunction with the content related to the specific purchase.

14. The method of claim 1, further comprising:
determining, based on the content related to the one or more purchases posted to the social networking service, that the user has earned a reward; and
providing the reward to the user via the social networking service.

15. The method of claim 1, further comprising:
determining, based on data posted within the social networking service, that a threshold number of social contacts of the user engaged in first purchases with a merchant of the one or more purchases; and
providing a reward to the user via the social networking service based on the threshold number of the social contact having engaged in the first purchases with the merchant.

16. The method of claim 15, wherein the first purchases comprise offline purchases.

17. A non-transitory computer-readable medium comprising instructions which, when executed by one or more computers, cause the one or more computers to implement a method, the method comprising:
receiving a representation of a set of purchases associated with a user of a social networking service;
determining, based on a first set of stored, predetermined rules for posting purchase information to the social networking service and for identifying that identify a portion of the set of purchases, one or more purchases from the set of purchases content related to which is to be posted to the social networking service, wherein the one or more purchases are not manually indicated by the user, and wherein the first set of stored predetermined rules for posting purchase information to the social networking service comprises rules based on a purchase price or a merchant type for a corresponding purchase; and
posting, in association with the user, the content related to the one or more purchases to the social networking service in response to determining that the content is to be posted to the social networking service.

18. The non-transitory computer-readable medium of claim 17, wherein at least one purchase in the set of purchases is associated with a merchant.

19. The non-transitory computer-readable medium of claim 18, wherein the first set of rules comprises at least one rule that is entered by the merchant and affirmatively approved by the user.

20. The non-transitory computer-readable medium of claim 17, wherein at least one rule within the first set of rules is not entered by the user.

21. A system comprising:
one or more processors; and
a memory comprising instructions which, when executed by the one or more processors, cause the one or more processors to implement a method, the method comprising:
receiving a representation of a set of purchases associated with a user of a social networking service;
determining, based on a first set of stored, predetermined rules for posting purchase information to the social networking service approved by the user and for identifying a portion of the set of purchases, one or more purchases from the set of purchases content related to which is to be posted to the social networking service, wherein the one or more purchases are not manually indicated by the user, and wherein the first set of stored predetermined rules for posting purchase information to the social networking service comprises rules based on a purchase price or a merchant type for a corresponding purchase; and
posting, in association with the user, the content related to the one or more purchases to the social networking service in response to determining that the content is to be posted to the social networking service.

22. The system of claim 21, wherein the method further comprises:
determining, based on the content related to the one or more purchases posted to the social networking service, additional information of interest to the user; and
presenting, via the social networking service, the additional information to the user.

23. The system of claim 22, wherein the additional information comprises an advertisement.
